(19) United States
(12) Patent Application Publication
(10) Pub. No.: US 2009/0274875 A1
(43) Pub. Date: Nov. 5, 2009

(54) POTTERY SLAB ROLLING MAT

(75) Inventors: Marylou Hornak, York, ME (US); Andrew Hornak, York, ME (US)

Correspondence Address: Andrew Hornak, 68 Linscott Rd, York, ME, 03909, US

(73) Assignees: Marylou Hornak, York, ME (US); Andrew Hornak, York, ME (US)

(21) Appl. No.: 12/363,762

(22) Filed: Jan. 31, 2009

Related U.S. Application Data
(60) Provisional application No. 61/025,747, filed on Feb. 1, 2008.

(51) Int. Cl. B32B 3/26

(52) U.S. Cl. 428/159; 428/221

(57) ABSTRACT

The invention pertains to a Pottery Slab Rolling Mat with surface which is fabricated and formed with characteristics to produce a smooth low surface tension with minuet air pockets which allow the release of ceramic or clay materials. The material used to formulate the Pottery Slab Rolling Mat is formulated of non-moister absorbing foam which together with the surface fabrication, allow simple and clean release of rolled ceramic or clay materials.

### CROSS-REFERENCE TO RELATED APPLICATION

This application claims priority under 35 USC §119 to U.S. Provisional Patent Application No. 61/025,747 Filed on Feb. 1, 2008.

### FIELD OF THE INVENTION

The invention relates to equipment or slab mat used by Potters for slab building of clay forms. This equipment or slab mat provides ease of use and simple release of clay slab. More specifically, it relates to the process and use of material for simple release of clay or ceramic slab.

### BACKGROUND OF THE INVENTION

The equipment is typically used by Sculptures and Potters or anyone requiring a surface for simple release of ceramic or clay slabs. These ceramic slabs are often rolled out on mats made of canvas, cloth, composite or organic material which can absorb moisture. This creates a condition which requires the mats to be dried before continuing to use the mat. The moisture prevents the clay from releasing easily, without sticking to the surface of the mat material.

Other means are used to create ceramic slabs, rubber, wax paper, plastic coated paper, smooth or shaped plastic surfaces are used. These surfaces often require release agents as talc, corn starch, oil, etc. This is done due to the clay or ceramic media adhering to the surface. These agents can also contaminate ceramic slab surfaces during joint attachment while forming pieces. This adds cost and additional effort to the formation of the ceramic slabs and work pieces.

### SUMMARY OF THE INVENTION

The invention defines material and use for simplifying clay or ceramic slab building. Although a number of materials have been used to create mats for slab building, they have not been able to provide long lasting method of doing so, without material break down do to moisture or the material, clay or ceramic media from sticking to the mats. The Clay or ceramic material readily adheres to smooth surfaces when air is forced out between the smooth non-porous surfaces of materials presently used on the market.

When clay or ceramic material is used on porous materials like paper, paper composites, fabric or canvas, it can be pressed into the material surface and cause sticking. The surface of the present mats can become moist also causing sticking. This invention provides a material and use to over come these issues.

The invention improves the production time by reducing the need for release agents or drying of the slab mat material between clay or ceramic slab creations. The material defined and being used in this invention has a smooth but matted surface which provides a means of to allow air to be maintained between the surface of the mat material and clay or ceramic slab. This air cushion is created at the surface due to the closed cell structure of the dense foam. The material used to create the mats is Ethylene Vinyl Acetate closed cell foam or EVA foam.

The invention provides a method of use of material to allow a continual formation of clay or ceramic material slabs. The material has a smooth surface which allows the creation of slabs with smooth un-textured surface. This overcomes ruff surface textures when canvas is used to form these slabs. The surfaces formed with canvas are hand worked to smooth surfaces, which adds time to the creation of slab work.

The invention can be used not only to provide smooth clean release surface, but can also be formed to give texture surface of different textures. Do to surface release of the material, textures can also be formed in the same fashion. The surface of the EVA foam can be textured and used to form simple to complex surface textures on the surface of the formed slab. Using a textured and non-textured mat on either side of the slab would create a slab of differing formations.

The material used in this invention is inherently non moisture absorbing and provides longer continual use do to this feature. Present formation of slabs use material which requires drying after short periods of use, reducing overall production time.

### BRIEF DESCRIPTION OF THE DRAWINGS

The accompanying drawings show the embodiment of the invention together with invention variations and modifications. Along with description used to explain the principles of the invention, in the drawings.

FIG. 1, Shows general functional view of rolling of a slab of ceramic or clay material between foam slab materials of invention.

FIG. 2 Shows the surface release details and materials inventive release details.

FIG. 3 Show alternate use of textured surface with un-textured or smooth surface foam mat.

FIG. 4, Hand rolling method of use of inventive foam material.

### DETAILED DESCRIPTION

The figures show the embodiment and detailed facets of the invention.

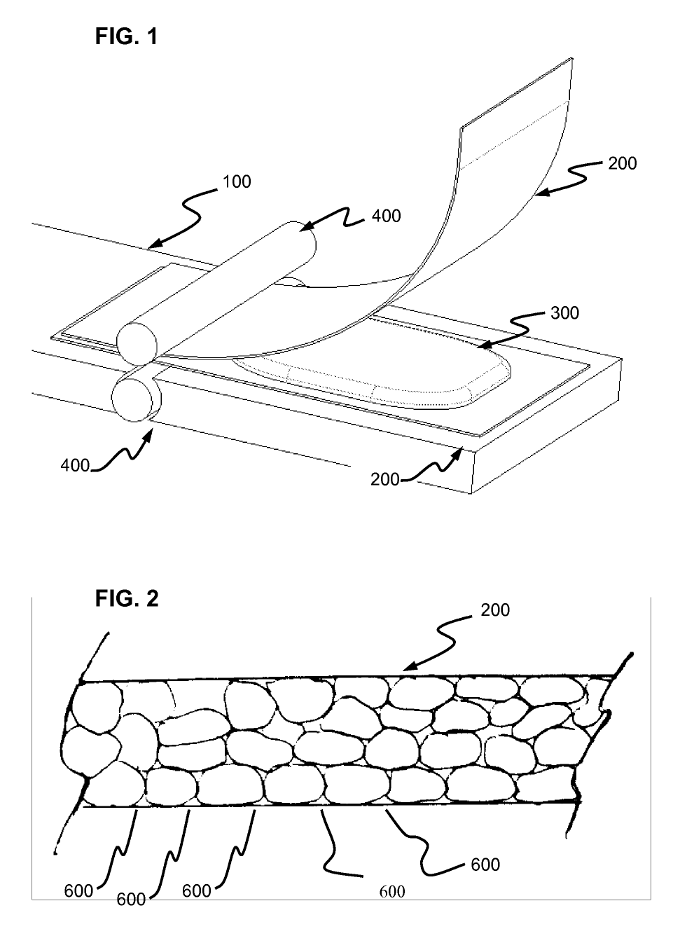

Referring now to FIG. 1, the drawing shows a slab of ceramic or clay material 300 between sheets of EVA foam 200. The EVA foam 200 is shown under and above the ceramic or clay material 300. The stake is then passed through rollers 400 as shown in the center of a table 100 or flat surface. This is done until a desired thickness of slab is achieved. Do to the EVA foams 200 surface characteristics discussed in FIG. 2 the EVA foam 200 easily release the ceramic or clay material 300.

FIG. 2 Shows cross section of EVA foam 200 identifying characteristic surface traits. Shown are surface air pockets 600 which help cushion and provide easier release of the ceramic or clay surface 300. EVA foam has a low surface tension which also provides additional release mechanism to the ceramic or clay surfaces 300. The release is made with out the use of other release agents as talc, corn starch, oil, etc. The inherent resistance to moister absorption prevents the material from becoming to moist during use. This moister absorption is a primary deterioration issue for other mats presently in use.

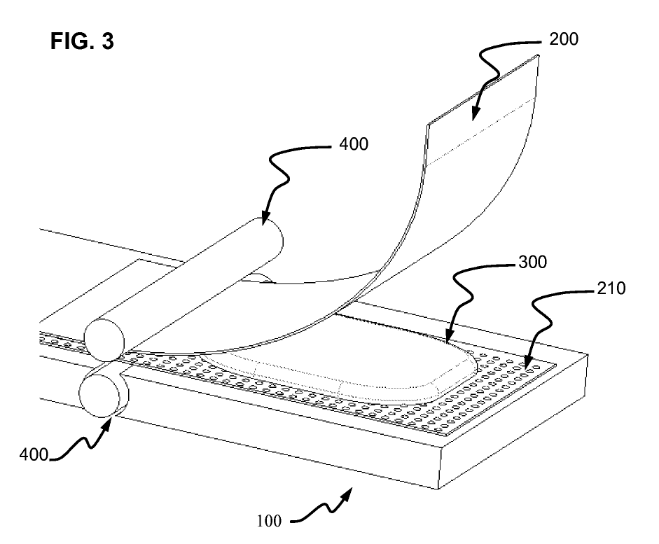

FIG. 3 The drawing shows a slab of ceramic or clay material 300 between sheets of EVA foam 200. The EVA foam 210 is shown under with textured surface and above EVA foam 200 with smooth surface. Surface characteristics as discussed in FIG. 2 allow the same release mechanism for the textured as well as non-textured EVA foam 200. The release of ceramic or clay material 300 is made with out the use of other release agents as talc, corn starch, oil, etc.

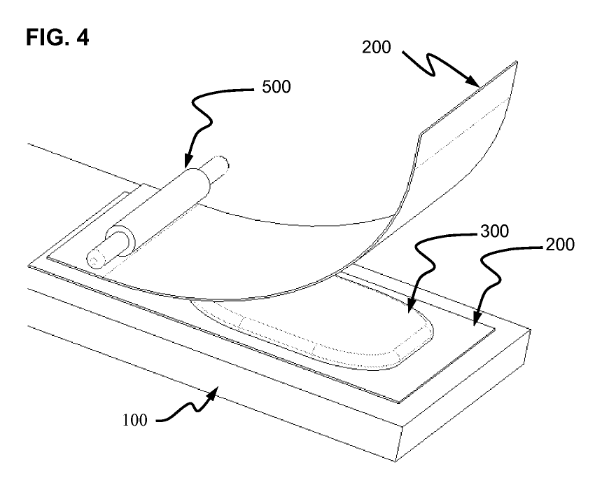

FIG. 4, Drawing shows a slab of ceramic or clay material 300 between sheets of EVA foam 200. The EVA foam 200 is shown under and above the ceramic or clay material 300. The stake is then rolled with a hand roller 500 as shown on a table 100 or flat surface. This is done until a desired thickness of slab is achieved. Do to the EVA foams 200 surface characteristics discussed in FIG. 2 the EVA foam 200 easily release the ceramic or clay material 300.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A Pottery Slab Rolling Mat comprising: of a surface which is formed to allow air pockets which are sized to allow cushion and clean release of ceramic or clay material from surface.

2. The Pottery Slab Rolling Mat in claim 1 which is fabricated to provide unique surface characteristics to produce a smooth low surface tension with minuet air pockets which allow the release of ceramic or clay materials.

3. The Pottery Slab Rolling Mat in claim 1 with low surface tension which allows added surface release of ceramic or clay materials.

4. The Pottery Slab Rolling Mat in claim 1 which is fabricated from non moister absorption material.

5. The Pottery Slab Rolling Mat in claim 1 which made with Ethylene Vinyl Acetate closed cell foam or EVA foam.

6. The Pottery Slab Rolling Mat in claim 5 which can be formed with contoured or formed surfaces, while still providing release functionally in claim 1-4.

7. The Pottery Slab Rolling Mat in claim 1 which will provide a smooth surface when ceramic or clay material is released.

8. The Pottery Slab Rolling Mat in claim 1 which can be formed for hand or machine rolling of ceramic or clay material slabs.
